(19) United States
(12) Patent Application Publication
(10) Pub. No.: US 2024/0400021 A1
(43) Pub. Date: Dec. 5, 2024

(54) VEHICLE BRAKE CYLINDER

(71) Applicant: ZF Active Safety GmbH, Koblenz (DE)

(72) Inventor: Johann Welsch, Weißenthurm (DE)

(21) Appl. No.: 18/678,865

(22) Filed: May 30, 2024

(30) Foreign Application Priority Data
Jun. 1, 2023 (DE) 102023114485.5

(51) Int. Cl. B60T 11/16

(52) U.S. Cl. CPC B60T 11/165

(57) ABSTRACT

A vehicle brake cylinder having a brake cylinder and having a piston rod attached to the brake piston provides for the piston rod to be mounted in a ball-receiving sleeve that is secured axially by a latching sleeve. To avoid damage to the brake piston as the latching sleeve is pushed in, the latching lobes have side margins with an inclination. A latching sleeve of said type is also proposed.

### CROSS-REFERENCE TO RELATED APPLICATIONS

This application claims priority to German Application No. 102023114485.5, filed Jun. 1, 2023, the disclosure of which is incorporated herein by reference in its entirety.

### TECHNICAL FIELD

The disclosure relates to a vehicle brake cylinder and to a latching sleeve in such a vehicle brake cylinder.

### BACKGROUND

Vehicle brake cylinders are, for example, master brake cylinders, though may also be other brake cylinders that are used for braking purposes in the vehicle, be it with or without brake force boosters.

Here, the brake pistons are moved by piston rods which, for example, ensure a direct coupling to the brake pedal or to some other drive means. An actuating force is transmitted via the piston rod to the brake pistons. Normally, the piston rods are connected via a ball joint to the brake piston in order to allow an angular deflection, that is to say the piston rod need not run parallel to the central axis of the brake piston. The movement of the ball head in the brake piston can lead to wear of the brake piston, for which reason a ball-receiving sleeve is interposed between the ball head and brake piston, which ball-receiving sleeve is positioned, and held in its setting, in the blind bore of the brake piston by a latching sleeve. Said latching sleeve has fingers or latching lobes which, after sliding along on a projection in the blind bore, spring outwards and assume the latched state. It is normally no longer possible for the latching sleeve to be uninstalled.

### SUMMARY

What is needed is to prevent damage to the facing side of the brake piston, that is to say the wall of the blind bore, when the latching sleeve is installed. Since the brake piston normally includes light metal such as aluminium, but the latching sleeve normally includes steel, damage could occur, specifically in the region of the projection, as the protruding fingers or latching lobes on the latching sleeve slide along on said projection.

Accordingly, a vehicle brake cylinder is disclosed, having a brake piston, a working chamber, which is provided in a housing and in which the brake piston is movable back and forth, and a piston rod, which at its piston-side end has a ball head in order to allow an angular deflection of the piston rod relative to the central axis of the brake piston. The brake piston has a blind bore which proceeds from an end side facing away from the working chamber and into which the piston rod projects, having a ball-receiving sleeve, which is seated in the blind bore and receives the ball. The brake piston also has a latching sleeve, which secures the ball-receiving sleeve axially in the blind bore, surrounds the piston rod, extends between the ball-receiving sleeve and a projection, projecting radially inwards into the blind bore, of the piston, and has, at its end facing away from the working chamber, at least one latching lobe protruding axially and radially outwards in inclined fashion, which latching lobe can be moved radially inwards when the latching sleeve is pushed into the blind bore and slides along on the projection. The latching sleeve, when installed, is latched behind the projection, and the at least one latching lobe is delimited by oppositely directed side margins and by a peripheral margin that connects the side margins. At least one side margin, in its region of contact with the projection during the pushing movement into the working chamber, extends in inclined fashion towards the opposite side margin.

When the latching sleeve is compressed to an increasing degree as it passes the projection, the side margins travel along the edge of the projection and cut into the projection. This is avoided, according to the disclosure, by an inclination of the side margin in the contact region, because the point of contact on the projection does not travel away from the associated latching lobe, that is to say the side margin does not cut into the projection.

The latching sleeve has, for example, a front end which faces towards the working chamber and which has a smaller outer dimension than the projection, such that no radial compression occurs in this region when this part of the latching sleeve is pushed through the projection. The latching sleeve widens towards its opposite end, in this case in the region of the latching lobes.

In one exemplary arrangement, in the direction of the front end, outer dimensions that cause jamming of the latching sleeve on the projection are encountered only proceeding from the start of the latching lobe.

In one exemplary arrangement, if at least one side margin extends entirely in inclined fashion as far as the peripheral margin, that is to say, proceeding from an adjoining ring portion that transitions into the latching lobes, the side margins or the side margin extends in inclined fashion in the direction of the peripheral margin.

The peripheral margin extends in a radial plane with respect to the central axis of the latching sleeve.

The inclination may have a constant angle as seen in a radial view, which applies if the cone is also constant. In other words, this means that, in that portion of the contact region in which the latching sleeve continuously widens (cone with a fixed angle), the inclination may also extend uniformly, in order to achieve that the point of contact does not move in the peripheral direction.

The inclination may transition with a radius into the peripheral margin, in order to avoid the occurrence of edges.

The side margins and the peripheral margin are produced, for example, by punching, and are not processed after the punching operation. The disclosure makes it possible for the margins to be left with a sharp edge, because there is no risk of this cutting into the projection. This reduces production costs.

The latching sleeve may thus be a deformed punched sheet-metal part.

The latching sleeve has a slot extending all the way through axially and radially, wherein the slot has such a width in a peripheral direction that the latching sleeve, as it is pushed into the blind bore, is compressed by virtue of the slot width being reduced. The narrowing of the latching sleeve in the region of the latching lobes can thus, if necessary, be achieved exclusively by virtue of the slot width being reduced, such that the latching lobes themselves can remain stable and do not need to be intrinsically elastically compressed.

The side margin or margins facing towards the slot, and for example, only these side margins, have the inclination. Alternatively, all side margins may have an inclination. This depends on where the side margins would move to during the compression of the latching sleeve.

A stable design of the latching sleeve is formed through the provision of exactly two latching lobes. The latching lobes are then of arcuate shape in an axial direction and thus stable, and can provide a large area of contact against the projection.

The angle of the inclination may be selected such that, as the latching sleeve is compressed as the at least one peripheral margin slides along on the projection, a point of contact between the particular peripheral margin and the projection does not move away from the associated latching lobe but remains static on the projection.

In the state in which the latching sleeve has not been elastically deformed, the at least one latching lobe may have a conical portion that is adjoined, in the direction of the peripheral margin, by a cylindrical portion or by a second conical portion with a smaller cone angle. This can reduce the force required to push the latching sleeve into the blind bore.

Parallel to the at least one latching lobe, at least one retaining finger may protrude axially from the rest of the latching sleeve, which at least one retaining finger lies against the projection on the side facing away from the working chamber. The latching sleeve is thus secured on the projection in both axial directions.

The disclosure has particular advantages if the piston is constructed of light metal, for example, of aluminium, and the ball-receiving sleeve and/or the latching sleeve is constructed of steel.

One variant of the disclosure provides for the piston, in its deployed position, to project partially out of the working chamber and to be surrounded in this region by a flange part out of which the piston rod projects. The flange part is commonly situated in the vehicle interior compartment, whereas the housing is situated in the engine compartment. The bulkhead is clamped in between. This means that the vehicle brake cylinder is installed on the bulkhead.

The disclosure furthermore also relates to a latching sleeve for a vehicle brake cylinder according to the disclosure, which latching sleeve has, at its end facing away from the working chamber, at least one latching lobe protruding axially and radially outwards in inclined fashion, which latching lobe can be moved radially inwards when a radially inwardly directed force acts on the latching sleeve. The at least one latching lobe is delimited by oppositely directed side margins and by a peripheral margin that connects the side margins. At least one side margin extends in inclined fashion towards the opposite side margin.

The latching sleeve may have one or more of the above features of the latching sleeve, and in any desired combination.

### BRIEF DESCRIPTION OF THE DRAWINGS

Further features and advantages of the disclosure will emerge from the following description and from the subsequent drawings, to which reference is made. In the drawings:

FIG. 1 is a longitudinal sectional view through a variant of a vehicle brake cylinder according to the disclosure,

FIG. 2 is a perspective view of a latching sleeve according to the disclosure of the vehicle brake cylinder according to FIG. 1,

FIG. 3 is an axial view showing the latching sleeve according to FIG. 2 as it is pushed into the brake piston,

FIG. 4 is an enlarged radial sectional view showing the latching sleeve sliding along on a projection in the brake piston,

FIG. 5 is an enlarged side view of the latching sleeve according to FIG. 2, and

FIG. 6 is a side view of a latching sleeve that does not conform to the disclosure.

### DETAILED DESCRIPTION

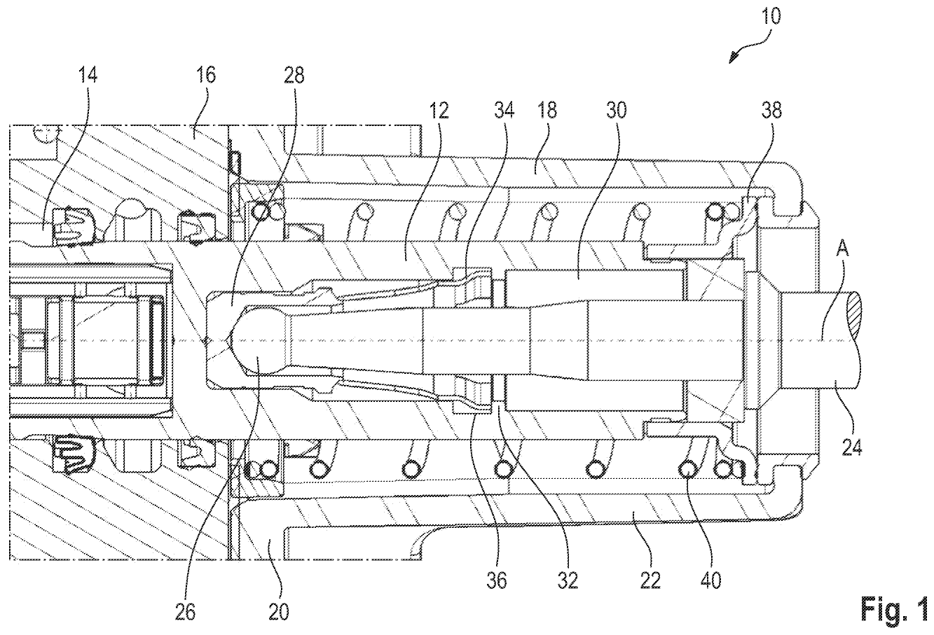

FIG. 1 illustrates a vehicle brake cylinder 10, for example a master brake cylinder.

The vehicle brake cylinder 10 comprises a brake piston 12, in this case constructed of light metal, for example, aluminium, which projects into a working chamber 14 of a housing 16 and is movable back and forth therein.

In a non-actuated, deployed position as illustrated in FIG. 1, the brake piston 12 projects partially out of the housing 16.

That part of the brake piston 12 which protrudes out from the housing 16 is surrounded by a flange part 18, said flange part having one or more radially protruding flanges 20 and having a pot-shaped portion 22 which adjoins the one or more flanges 20 and which surrounds the part of the brake piston 12 outside the housing 16.

The pot-shaped portion 22 has an open end side through which a piston rod 24 projects into a hollow interior of the brake piston 12. The piston rod 24 serves to produce a mechanical connection between, for example, a brake pedal and the brake piston 12, and to move the brake piston 12 deeper into the working chamber 14.

The piston rod 24 has, at least at its piston-side end, for example at the two opposite ends, a ball head 26 that allows an angular deflection of the piston rod 24 relative to the central axis A of the brake piston 12.

The ball head 26 is received in a ball-receiving sleeve 28, which has been pushed into a blind bore 30 of the hollow brake piston 12 and is seated therein with an accurate radial fit and abuts against the base of the blind bore 30.

In one exemplary arrangement, the ball-receiving sleeve 28 is constructed of steel and is intended to prevent the ball head 26, which, like the piston rod 24, is constructed of steel, from damaging the softer material of the brake piston 12.

The ball-receiving sleeve 28 must be axially secured. For this purpose, a latching sleeve 34 is provided between the ball-receiving sleeve 28 and a radially inwardly protruding projection 32 on the inside of the blind bore 30.

Said latching sleeve 34 is pushed axially into the blind bore 30 and becomes narrower as it slides along on the projection 32, wherein, after passing the projection 32, said latching sleeve, at its end facing away from the working chamber 14, springs back and engages behind the projection 32.

In the region downstream of the projection 32 in the pushing-in direction, the blind bore 30 has, for example, a groove 36 into which the end of the latching sleeve 34 can engage with spring action.

On the brake piston 12, at its end situated opposite the working chamber 14, there is mounted a carrier part 38 which has a radially outwardly protruding projection on which a restoring spring 40 is supported.

The restoring spring 40 serves to move the brake piston into the position shown in FIG. 1.

The vehicle brake cylinder 10 is installed on the bulkhead of the vehicle.

The housing 16 together with the brake piston 12 and the piston rod 24 are inserted from the engine side, wherein that part of the brake piston 12 which projects out of the housing 16, and the piston rod 24, are passed through an opening in the bulkhead. The restoring spring 40 is optionally also already installed at this point in time, but this is not imperatively the case.

Subsequently, proceeding from the vehicle interior compartment, the flange part 18 is mounted and is screwed onto the bulkhead, with the bulkhead being penetrated and a screw connection being made into the housing 16, in order to clamp the bulkhead between the flange part 18 and the housing 16.

As can be seen in FIG. 1, the latching sleeve 34 has an altogether conical shape in which the front end, that is to say the end facing towards the working chamber 14, has a smaller dimension than the opening in the region of the projection 32, and the opposite end has a dimension larger than the clear width of the opening in the region of the projection 32.

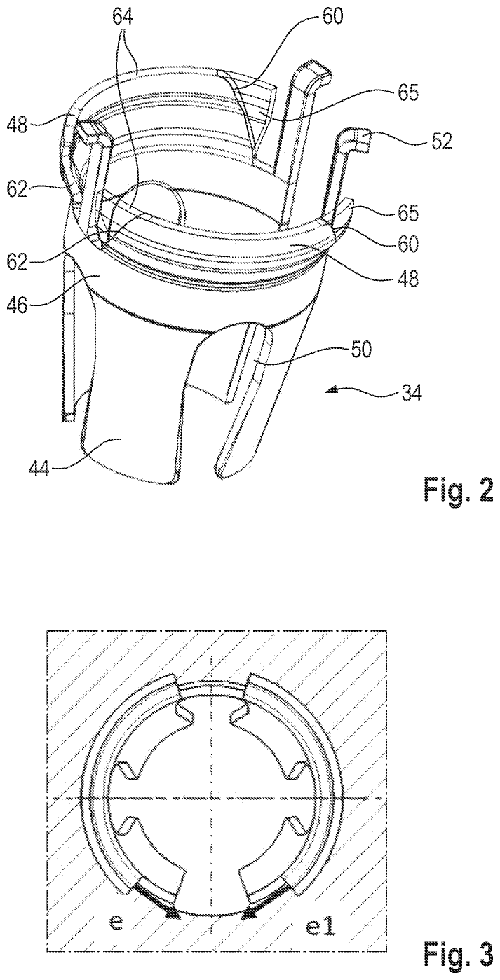

It can be seen in FIG. 2 that the latching sleeve 34 has multiple peripherally distributed, mutually spaced flat fingers 44 in the front region, and adjoining these has a ring portion 46, which is followed by latching lobes 48 which extend radially outwards from the ring portion 46 in inclined fashion and form the latching projections.

The latching sleeve 34 is a slotted sleeve having a linear slot 50 extending all the way through radially and axially.

The two latching lobes 48 extend over a segment of a ring portion.

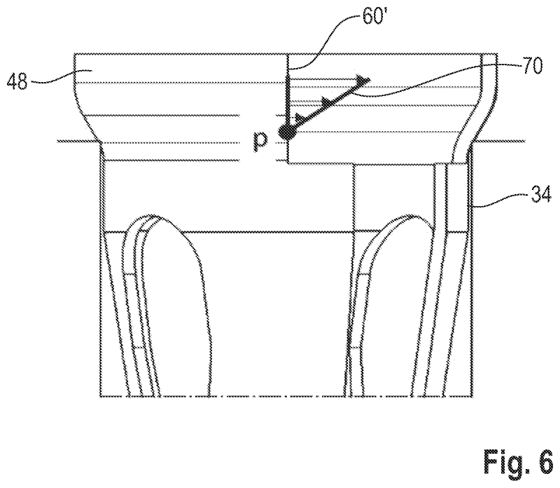

Extending between the latching lobes 48 are axially protruding, L-shaped retaining fingers 52 which protrude integrally from the ring portion 46 and which are axially longer than the latching lobes 48. By way of their radially outwardly angled ends, the retaining fingers 52 lie against that side of the projection 32 which faces away from the working chamber 14. Owing to the section plane that has been chosen in FIG. 1, the retaining fingers are not visible here. For the sake of simplicity, said retaining fingers are not illustrated in FIGS. 5 and 6.

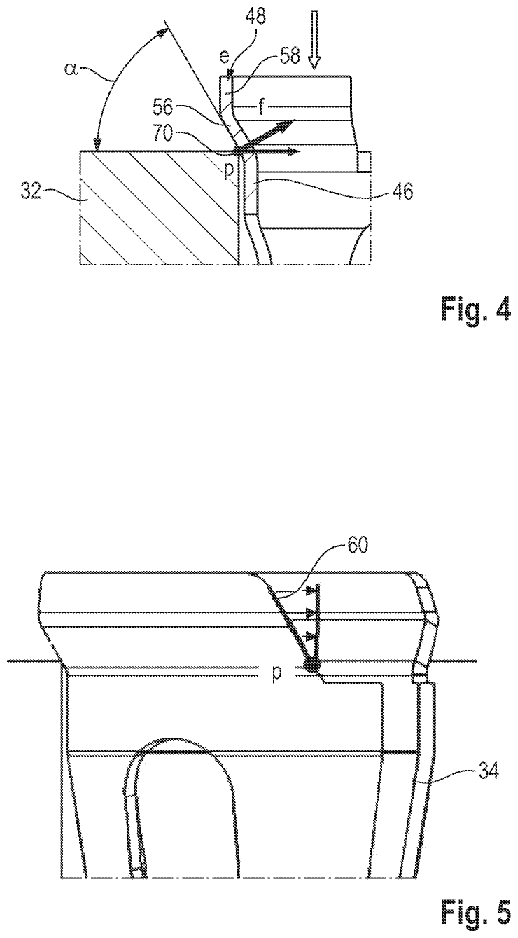

Proceeding from the ring portion 46, the latching lobes 48 initially extend conically outwards (see FIG. 4) so as to form a conical portion 56 with an angle α here. Said conical portion 56 is adjoined by a cylindrical portion 58, which may however also be designed as a conical portion but with a cone angle smaller than the angle α.

Each latching lobe 48 is bordered by a margin that has three margin portions, specifically two side margins 60, 62, which point in opposite directions, and a peripheral margin 64, which connects the two side margins 60, 62 and which defines the axial end of the particular latching lobe 48.

In one exemplary arrangement, the peripheral margin 64 lies in a radial plane so as to be able to form an area of contact or a line of contact with the rear side of the projection 32.

The side margins 60, 62, for example, those two side margins 60 of the latching lobes 48 which face towards one another and which are adjacent to the slot 50, extend, in the direction of the peripheral margin 64, in inclined fashion towards the opposite side margin 62 of their associated latching lobes 48. This means that, as viewed in the peripheral direction, the length of the latching lobe 48 decreases the closer the corresponding portion of the side margin 60 is to the peripheral margin 64.

The inclined profile of the side margins 60, 62 is indicated in FIG. 2 by virtue of a triangular portion 65 being indicated adjacent to said side margins 60, 62, which triangular portion is not actually present but symbolizes an imaginary portion that would exist in the presence of a different side margin, specifically one extending parallel to the central axis of the latching sleeve 34 as seen in a radial view.

When the latching sleeve 34 is inserted into the blind bore 30 and pushed past the projection 32, only the latching lobes 48 make contact with the projection 32 in such a way that a radial force is exerted on the latching lobes 48 via the projection 32, which radial force causes a compression of the slotted latching sleeve 34 such that the peripheral width of the slot 50 is reduced.

FIG. 3 shows that, in this situation, the side margins 60 of the latching lobes 48 are moved towards one another in the direction of the arrows. However, since the side margins 60, 62 may have sharp edges, they could cut into the projection 32 constructed of light metal and cause chipping, which must be avoided.

FIG. 4 illustrates the dimensions during the pushing-in operation, and a point of contact p between the outer side of the latching lobe 48, in this case in the region of the conical portion 56, and the edge 70 on the projection 32, on which the latching lobes 48 slide along. That region of the latching lobes which slides along on the projection as the latching sleeve 34 is pushed in is referred to as the contact portion.

If the side margins 60, 62 extended parallel to the central axis, as illustrated in FIG. 6, then the side margin 60′, and with it the point of contact p, would travel further to the right owing to the conical latching lobe 48. This would occur owing to the compression of the latching sleeve 34, which, with the outwardly widening cone, is compressed to an increasing degree the deeper the latching sleeve 34 is pushed into the blind bore 30 along the projection 32. This movement of the side margin 60′ would however lead to a cutting movement owing to the relative movement between the side margin 60′ and the edge 70.

However, if the side margin or margins 60 and optionally also the side margins 62 are provided with an inclination as seen in a radial view, the point of contact p does not travel in a peripheral direction along the edge 70.

Depending on the profile of the inclination, the point of contact p may remain static or even travel in the opposite direction (if the inclination were more pronounced than that in FIG. 5). The point of contact p would then perform a sidewards movement, specifically in the direction of the particular latching lobe 48 or the centre of the particular latching lobe 48 in the peripheral direction, as the latching sleeve 34 is pushed in.

The inclination is in any case selected such that the point of contact p between the particular peripheral margin and the projection does not travel in a direction away from the associated latching lobe, as illustrated in FIG. 6.

This special design of the side margins 60, 62 also makes it possible for the latching sleeve 34 to be formed as a deformed sheet-metal punched part, in which it is even the case that the side margins 60, or even the latching sleeve 34 as a whole, are or is not processed after the punching operation.

1. A vehicle brake cylinder, comprising:
a brake piston which has a working chamber, the working chamber provided in a housing and in which the brake piston is movable back and forth, and
a piston rod, which at its piston-side end has a ball head in order to allow an angular deflection of the piston rod relative to a central axis of the brake piston,
wherein the brake piston has a blind bore which proceeds from an end side facing away from the working chamber and into which the piston rod projects, having a ball-receiving sleeve, which is seated in the blind bore and receives the ball, and having a latching sleeve, which secures the ball-receiving sleeve axially in the blind bore, surrounds the piston rod, extends between the ball-receiving sleeve and a projection, projecting radially inwards into the blind bore, of the piston, and has, at its end facing away from the working chamber, at least one latching lobe protruding axially and radially outwards in inclined fashion, which latching lobe can be moved radially inwards when the latching sleeve is pushed into the blind bore and slides along on the projection,
wherein the latching sleeve, when installed, is latched behind the projection, and the at least one latching lobe is delimited by oppositely directed side margins and by a peripheral margin that connects the side margins,
wherein at least one side margin, in a region of contact with the projection during a pushing movement into the working chamber, extends in inclined fashion towards the opposite side margin.

2. The vehicle brake cylinder according to claim 1, wherein at least one side margin extends entirely in inclined fashion as far as the peripheral margin.

3. The vehicle brake cylinder according to claim 1, wherein the inclination has a constant angle as seen in a radial view.

4. The vehicle brake cylinder according to claim 1, wherein the inclination transitions with a radius into the peripheral margin.

5. The vehicle brake cylinder according to claim 1, wherein the side margins and the peripheral margin are produced by punching.

6. The vehicle brake cylinder according to claim 5, wherein the latching sleeve is a deformed punched sheet-metal part.

7. The vehicle brake cylinder according to claim 1, wherein the latching sleeve has a slot extending all the way through axially and radially, and the slot has such a width in a peripheral direction that the latching sleeve, as it is pushed into the blind bore, is compressed by virtue of the slot width being reduced.

8. The vehicle brake cylinder according to claim 7, wherein the side margin or margins facing towards the slot have the inclination.

9. The vehicle brake cylinder according to claim 7, wherein exactly two latching lobes are provided.

10. The vehicle brake cylinder according to claim 1, wherein the angle of the inclination is selected such that, as the latching sleeve is compressed as the at least one peripheral margin slides along on the projection, a point of contact between the particular peripheral margin and the projection does not move away from the associated latching lobe but in remains static on the projection.

11. The vehicle brake cylinder according to claim 1, wherein in the state in which the latching sleeve has not been elastically deformed, the at least one latching lobe has a conical portion that is adjoined, in the direction of the peripheral margin, by a cylindrical portion or by a second conical portion with a smaller cone angle.

12. The vehicle brake cylinder according to claim 1, wherein, parallel to the at least one latching lobe, at least one retaining finger protrudes axially from the rest of the latching sleeve and lies against the projection on the side facing away from the working chamber.

13. The vehicle brake cylinder according to claim 1, wherein the piston is constructed of light metal, and the ball-receiving sleeve and/or the latching sleeve is constructed of steel.

14. The vehicle brake cylinder according to claim 1, wherein the piston, in its deployed position, projects partially out of the working chamber and is surrounded in this region by a flange part out of which the piston rod projects.

15. A latching sleeve for a vehicle brake cylinder the latching sleeve comprising, at its end facing away from a working chamber of the vehicle brake cylinder, at least one latching lobe protruding axially and radially outwards in inclined fashion, the latching lobe can be moved radially inwards when a radially inwardly directed force acts on the latching sleeve, wherein the at least one latching lobe is delimited by oppositely directed side margins and by a peripheral margin that connects the side margins, wherein at least one side margin extends in inclined fashion towards the opposite side margin.

16. The latching sleeve according to claim 15, wherein the latching sleeve has at least one of the following features:
at least one side margin extends entirely in inclined fashion as far as the peripheral margin;
the inclination has a constant angle as seen in a radial view;
the inclination transitions with a radius into the peripheral margin;
the side margins and the peripheral margin are produced by punching;
the latching sleeve is a deformed punched sheet-metal part;
the latching sleeve has a slot extending all the way through axially;
the side margin or margins facing towards the slot have the inclination;
exactly two latching lobes are provided;
in a state in which the latching sleeve has not been elastically deformed, the at least one latching lobe has a conical portion that is adjoined, in a direction of the peripheral margin, by a cylindrical portion or by a second conical portion with a smaller cone angle;
parallel to the at least one latching lobe, at least one retaining finger protrudes axially from the rest of the latching sleeve, which at least one retaining finger is axially longer than the at least one latching lobe and has a radially outwardly projecting free end; and
the latching sleeve is constructed of steel.

17. The vehicle brake cylinder according to claim 5, wherein the side margins and the peripheral margin are not processed after the punching operation.

18. The vehicle brake cylinder according to claim 8, wherein only the side margins facing the slot have the inclination, or in that all side margins have an inclination.

19. The vehicle brake cylinder according to claim 8, wherein all side margins have an inclination.
